(19) United States
(12) Patent Application Publication
(10) Pub. No.: US 2023/0392274 A1
(43) Pub. Date: Dec. 7, 2023

(54) Reference Electrode for Molten Salts

(71) Applicant: ALPHA TECH RESEARCH CORP, Salt Lake City, UT (US)

(72) Inventors: John N. Harb, Woodlands, UT (US); Michael Stoddard, Springville, UT (US)

(21) Appl. No.: 18/250,205

(22) PCT Filed: Jun. 29, 2021
(86) PCT No.: PCT/US21/39705

§ 371 Date: Apr. 21, 2023

(51) Int. Cl. C25C 7/02; C25C 3/34; C25C 7/04

(52) U.S. Cl. CPC C25C 7/025; C25C 3/34; C25C 7/04

(57) ABSTRACT

Some embodiments include a molten salt system comprising: a molten salt enclosure; a molten salt disposed within the molten salt enclosure; a working electrode disposed at least partially within the molten salt; a counter electrode disposed at least partially within the molten salt; a separator barrier disposed at least partially within the molten salt; a reference salt disposed within the separator barrier; and a reference wire disposed within the reference salt.

### BACKGROUND

Current molten salt reference electrodes include quasi-reference electrodes, dynamic reference electrodes, and metal/metal ion reference electrodes.

### SUMMARY

Some embodiments include a reference electrode that includes a separator barrier (e.g., a membrane or an ion permeable barrier) comprising a membrane that is configured to be disposed at least partially within a molten salt; a reference salt disposed within the separator barrier; and a reference wire disposed within the reference salt.

In some embodiments, the separator barrier allows for transport of at least one ion through the membrane. In some embodiments, the separator barrier comprises an anion exchange membrane. In some embodiments, the separator barrier comprises boron nitride. In some embodiments, the separator barrier comprises a diffusion barrier.

In some embodiments, the reference salt comprises two soluble ions in the reference salt. In some embodiments, a redox reaction occurs between two ions within the reference salt. In some embodiments, the ions are different oxidation states of uranium. In some embodiments, the reference salt comprises the molten salt with either or both UF4 or UF3. In some embodiments, the reference salt comprises ions more reactive than metals in the reference wire.

In some embodiments, the reference wire comprises any metal that is minimally reactive with respect to uranium and/or the reference salt and/or the molten salt. In some embodiments, the reference wire is stable with respect to uranium and/or the reference salt and/or the molten salt. In some embodiments, the reference wire comprises tungsten. In some embodiments, the reference wire comprises a metal that is less reactive than ions in the reference salt.

Some embodiments include a molten salt electrochemical cell comprising: a molten salt enclosure; a molten salt disposed within the molten salt enclosure; a working electrode disposed at least partially within the molten salt; a counter electrode disposed at least partially within the molten salt; and a reference electrode. The reference electrode may include a separator enclosure disposed at least partially within the molten salt; a reference salt disposed within the separator enclosure; and a reference wire disposed within the reference salt.

In some embodiments, molten salt comprises a fluoride-based molten salt such as, for example, either or both FLiBe and FLiNaK.

In some embodiments, the reference salt comprises a fluoride-based salt, (e.g., either or both FLiBe and FLiNaK) with either or both UF4 and UF3. In some embodiments, the reference salt comprises the molten salt with uranium such as, for example, either or both UF4 and UF3.

In some embodiments, the reference salt comprises other ions more reactive than metals in the reference wire.

In some embodiments, either or both the molten salt and the reference salt may comprise a chloride salt with uranium.

In some embodiments, the reference wire comprises any metal that is minimally reactive with uranium or the salt. In some embodiments, the reference wire comprises tungsten. In some embodiments, the reference wire comprises a metal that is less reactive than ions in the reference salt.

In some embodiments, the separator barrier comprises boron nitride.

The various embodiments described in the summary and this document are provided not to limit or define the disclosure or the scope of the claims.

### BRIEF DESCRIPTION OF THE FIGURES

FIG. 1 is an illustration of a molten salt electrochemical system according to some embodiments.

### DETAILED DESCRIPTION

Some embodiments include a reference electrode for a molten salt systems (e.g., electrochemical cell or a molten salt reactor). The reference electrode, for example, can operate based on the U(IV)/U(III) redox couple and/or may enable accurate electrochemical measurements in fluoride-based molten salts. Because measurement of electric potential is relative, only potential differences can be measured, it may be important in some situations to have a stable reference of known potential to which all other potentials can be referenced or measured. A reference electrode can be used to provide that reference in order to enable accurate, reproducible measurement and application of potential. A reliable and stable reference electrode, for example, may be required to study and/or monitor a variety of physical and chemical phenomena including corrosion, fission product chemistry, and/or molten salt properties.

With a reference electrode, for example, the redox reaction occurs between two ions within a reference salt rather than between an electrode wire and an ion in the salt.

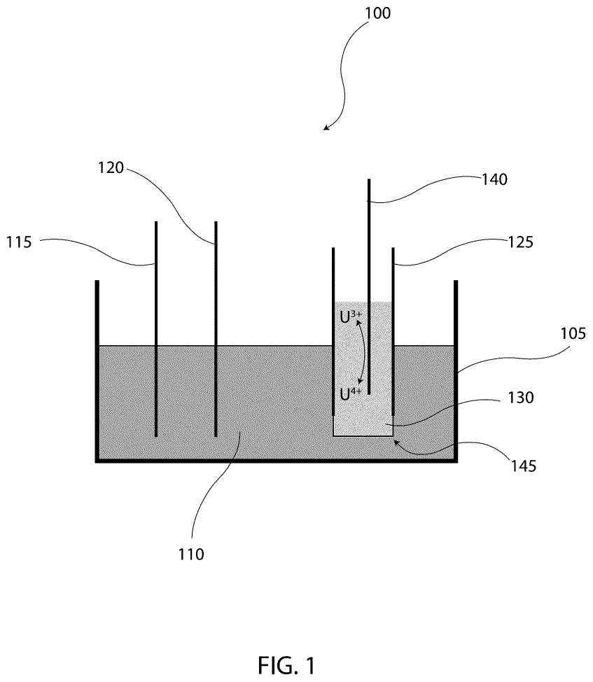

FIG. 1 is an illustration of a molten salt electrochemical cell 100 according to some embodiments. The molten salt electrochemical cell 100, for example, may include a molten salt system. The molten salt electrochemical cell 100, for example, may be utilized in any type of molten salt system or device including, but not limited to, thermal spectrum nuclear reactors, fast spectrum nuclear reactors, epithermal spectrum nuclear reactors, molten salt test loops, molten salt targets, molten salt neutron sources, etc.

The molten salt electrochemical cell 100, for example, may include a molten salt enclosure 105; a molten salt 110 disposed within the molten salt enclosure; a working electrode 115 disposed at least partially within the molten salt; a counter electrode 120 disposed at least partially within the molten salt 110; and a reference wire 140 disposed at least partially within the molten salt 110. The reference wire 140, for example, may include a separator barrier 125, a reference salt 130 disposed within the separator barrier; and a reference wire 140 disposed within the reference salt 130.

The molten salt enclosure 105, for example, may include any type of enclosure.

The molten salt 110, for example, may be disposed within the molten salt enclosure 105. The molten salt 110, for example, may include LiF, NaF, KF, BeF2, MgF2, CaF2, ZrF4, ThF4, and/or UF4.

The molten salt 110, for example, may include fluoride salts (e.g., FLiBe: lithium fluoride (LiF) and beryllium fluoride (BeF₂)) with dissolved uranium (U-235 or U-233) fluorides (e.g., UF₄). Uranium, for example, may be low-enriched uranium, unenriched uranium, or enriched uranium.

The molten salt 110, for example, may employ one or more molten salts with a fissile material. The molten salt 110, for example, may include any salt comprising fluorine, chlorine, lithium, sodium, potassium, beryllium, zirconium, rubidium, etc., or any combination thereof. The molten salt 110, for example, may include LiF, LiF—BeF₂, 2Li—F—BeF₂, LiF—BeF₂—ZrF₄, NaF—BeF₂, LiF—NaF—BeF₂, LiF—ZrF4, LiF—NaF—ZrF4, KF—ZrF4, RbF—ZrF4, LiF—KF, LiF—RbF, LiF—NaF—KF, LiF—NaF—RbF, BeF2—NaF, NaF—BeF2, LiF—NaF—KF, etc. The molten salt 110, for example, may include sodium fluoride, potassium fluoride, aluminum fluoride, zirconium fluoride, lithium fluoride, beryllium fluoride, rubidium fluoride, magnesium fluoride, and/or calcium fluoride.

The molten salt 110, for example, may include any of the following possible salt eutectics. Many other eutectics may be possible. The following list also includes molar ratios and the melting point of the example eutectics. The molar ratios are examples only. Various other eutectics may be used.
LiF—NaF (60-40 mol %) 652° C.
LiF—KF (50-50 mol %) 492° C.
LiF—NaF—KF (46.5-11.5-42 mol %) 454° C.
LiF—NaF—CaF₂ (53-36-11 mol %) 616° C.
LiF—NaF—MgF₂—CaF₂ (˜50-˜30-˜10-˜10 mol %) ˜600° C.
LiF—MgF₂—CaF₂ (˜65-˜12-˜23 mol %) 650-725° C.
LiF—BeF₂ (66.5-33.5 mol %) 454° C.
NaF—BeF₂ (69-31 mol %) 570° C.
LiF—NaF—BeF₂ (15-58-27) 480° C.
LiF—NaF—ZrF₄ (37-52-11) 604° C.
LiF—ThF₄ (71-29) 565° C.
NaF—ThF₄ (77.5-22.5) 618° C.
NaF—ThF₄ (63-37) 690° C.
NaF—ThF₄ (59-41) 705° C.
LiF—UF₄ (73-27) 490° C.
NaF—UF₄ (78.5-21.5) 618° C.
LiF—NaF—UF₄ (24.3-43.5-32.2) 445° C.

The molten salt 110, for example, may comprise a chloride salt.

The working electrode 115 and/or the counter electrode 120, for example, may be disposed at least partially within the molten salt 110. The working electrode 115, for example, and/or the counter electrode 120 may include any type of standard electrode material such as, for example, graphite, platinum, molybdenum, tungsten, etc.

The separator barrier 125, for example, may be disposed at least partially within the molten salt 110. The separator barrier 125, for example, may separate the reference salt 130 from the molten salt 110. The separator barrier 125, for example, may allow or only allow anions (e.g., F⁻) through the barriers of the separator barrier 125. The separator barrier 125, for example, may include barriers comprised of LaF3 crystal. The separator barrier 125, for example, may comprise a membrane or diffusion barrier. The separator barrier 125, for example, may allow for transport of at least one ion such as, for example, an anion. The separator barrier 125, for example, may restrict the flow of anions into and out of the separator barrier 125.

The separator barrier 125, for example, may include a boron nitride tube (with or without a LaF3 crystal) as an interface between the reference salt 130 and the molten salt 110. Boron nitride (or doped boron nitride), for example, may become porous and/or may provide a diffusion barrier between the molten salt 110 and the reference salt 130. As another example, boron nitride may become saturated with molten salt creating ionic contact.

The separator barrier 125, for example, may comprise boron nitride, oped boron nitride, mullite, alumina, LaF3 crystal, and/or graphite.

The reference salt 130, for example, may be disposed within the separator barrier 125. The reference salt 130, for example, include ions that are less reactive than metals in the reference wire 140. The reference salt 130, for example, include a salt similar to the molten salt 110 with two ions disposed or mixed within.

The separator barrier 125, for example, may have a thinner portion 145 such that the separator barrier 125 may be thinner than other portions of the separator barrier 125. The thinner portion 145, for example, may facilitate and/or increase ion transport. Alternatively or additionally, the separator barrier 125, for example, may have the same thickness throughout the separator barrier 125 including the thinner portion 145.

The separator barrier 125, for example, may allow for selective anion passage between the molten salt 110 and the reference salt 130.

The reference salt 130, for example, include LiF, NaF, KF, BeF2, MgF2, CaF2, ZrF4, ThF4, and/or UF4. The reference salt 130, for example, substantially match the molten salt 110.

A redox reaction, for example, may occur within the reference salt 130 between two ions of the same element. For example, any of the following or other redox couples may occur:
U⁴⁺+e⁻→U³⁺
Zr⁴⁺+2e⁻→Zr²⁺
Cr³⁺+e⁻→Cr²⁺
Fe³⁺e⁻→Fe²⁺
Mn³⁺+e⁻→Mn²⁺
V⁵⁺+2e⁻→V³⁺.

A redox reaction, for example, may occur between two ions as shown with these redox couples within the reference salt. Reduction and oxidization species may occur, for example, within the reference salt rather than as part of the reference electrode. The reference salt, for example, may include uranium ions such as, for example, U3+ and/or U4+.

The reference wire 140, for example, may be disposed within the reference salt 130. The reference wire 140, for example, may include any inert metal such as, for example, molybdenum, tungsten, platinum, or any noble metal. The reference wire 140, for example, may include any inert electron conductor such as, for example, a metal, platinum or glassy carbon.

The reference wire 140, for example, may comprise Tungsten, Molybdenum, Copper, Platinum, Glassy Carbon, Silver, and/or Gold.

The reference wire 140, for example, may include any metal that is stable within the reference salt. The stable metal, for example, may provide increased stability and lifetime over reference electrodes that use reactive metals.

If the reference salt ions do not form insoluble precipitates, for example, then the reference wire 140 may be much less sensitive to water and oxygen contamination in the reference salt. Hence, a reference electrode potential may be more stable than that of other types of reference electrodes in the presence of contamination.

When the concentration of the reference salt 130 contains a sufficiently high concentration of reference ions (for example, Ni2+, Ag+, or U4+/U3+), for example, these ions may begin to interact with each other. This may make the potential of the reference wire 140 difficult to predict and compare to other types of reference electrodes (e.g., even other reference electrodes that use the same chemistry but at a different concentration). This effect may be diminished when both ions are in solution because the corrections tend to cancel each other out to a large extent; therefore, the uranium reference electrode may be more predictable (e.g., able to be described with the Nernst equation) at higher concentrations than either the Ni or Ag reference electrode.

A reference electrode as disclosed in this document, for example, may be better in dirty salts and/or over long periods of time.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A reference electrode, comprising:
a separator barrier comprising a membrane that is configured to be disposed at least partially within a molten salt;
a reference salt disposed within the separator barrier; and
a reference wire disposed within the reference salt.

2. The reference electrode according to claim 1, wherein the separator barrier allows for transport of at least one ion through the membrane.

3. The reference electrode according to claim 1, wherein the reference salt comprises two soluble ions in the reference salt.

4. The reference electrode according to claim 1, wherein the reference salt comprises a fluoride-based salt.

5. The reference electrode according to claim 1, wherein the reference salt comprises any mixture of LiF, NaF, KF, BeF₂, MgF₂, CaF₂, ZrF₄, ThF₄, UF₃, and/or UF₄.

6. The reference electrode according to claim 1, wherein the reference salt comprises a salt mixture with two soluble ions of the same metal or metal complex at different oxidation states.

7. The reference electrode according to claim 1, wherein the reference salt comprises at least one of U⁴⁺/U³⁺, Zr⁴⁺/Zr²⁺, Cr³⁺/Cr²⁺, Fe³⁺/Fe²⁺, Mn³⁺/Mn²⁺ and/or V⁵⁺/V³⁺.

8. The reference electrode according to claim 1, wherein the reference salt comprises uranium at two different valence states.

9. The reference electrode according to claim 1, wherein the separator barrier comprises a material that allows for transport of at least one ion through the membrane. The reference electrode according to claim 1, wherein the separator barrier comprises an anion exchange membrane and/or a diffusion barrier.

11. The reference electrode according to claim 1, wherein the separator barrier comprises of a material that is stable to both the molten salt and the reference salt.

12. The reference electrode according to claim 1, wherein the separator barrier comprises boron nitride, doped boron nitride, alumina, macor, graphite, and/or lanthanum fluoride crystal.

13. The reference electrode according to claim 1, wherein the reference salt comprises the molten salt with UF₄ and UF₃.

14. The reference electrode according to claim 1, wherein the reference wire comprises any metal that is minimally reactive and/or stable with respect to uranium and/or the reference salt and/or the molten salt.

15. The reference electrode according to claim 1, wherein the reference wire comprises is stable with respect to uranium and/or the reference salt and/or the molten salt.

16. The reference electrode according to claim 1, wherein the reference wire comprises tungsten.

17. A molten salt system comprising:
a molten salt enclosure;
a molten salt disposed within the molten salt enclosure;
a working electrode disposed at least partially within the molten salt;
a counter electrode disposed at least partially within the molten salt;
a separator barrier disposed at least partially within the molten salt;
a reference salt disposed within the separator barrier; and
a reference wire disposed within the reference salt.

18. The molten salt system according to claim 17, wherein the molten salt comprises either or both FLiBe and FLiNaK.

19. The molten salt system according to claim 17, wherein the molten salt comprises any chloride-based molten salt or any fluoride-based molten salt.

20. The molten salt system according to claim 17, wherein the reference salt comprises either or both FLiBe and FLiNaK with UF₄ and UF₃.

21. The molten salt system according to claim 17, wherein the reference salt comprises the molten salt with either or both UF₄ and UF₃.

22. The molten salt system according to claim 17, wherein the reference salt comprises ions more reactive than metals in the reference wire.

23. The molten salt system according to claim 17, wherein the reference wire comprises a metal that is less reactive than ions in the reference salt.
